(19) United States
(12) Patent Application Publication
(10) Pub. No.: US 2009/0326834 A1
(43) Pub. Date: Dec. 31, 2009

(54) Systems, methods and computer program products for characterizing structural events

(76) Inventors: Mannur J. Sundaresan, Greensboro, NC (US); Mark J. Schulz, Westchester, OH (US); Francis Nkrumah, Greensboro, NC (US); Gangadhararai Grandhi, Greensboro, NC (US)

Correspondence Address: MYERS BIGEL SIBLEY & SAJOVEC, PO BOX 37428, RALEIGH, NC, 27627, US

(21) Appl. No.: 11/271,156

(22) Filed: Nov. 10, 2005

Related U.S. Application Data
(60) Provisional application No. 60/627,665, filed on Nov. 12, 2004.

(51) Int. Cl. G06F 19/00; G06F 15/00

(52) U.S. Cl. 702/34; 702/188

(57) ABSTRACT

Sensor assemblies for non-destructively monitoring a structure to detect a structural event include a plurality of sensor nodes configured to provide at least one sensor signal responsive to a structural event. A signal analyzer is configured to compare the sensor signal to a reference database of signal characteristics corresponding to respective structural events.

### RELATED APPLICATIONS

This application claims priority to U.S. Provisional Application Ser. No. 60/627,665 filed Nov. 12, 2004, the disclosure of which is hereby incorporated by reference in its entirety.

### BACKGROUND OF THE INVENTION

(1) Field of the Invention

The present invention relates generally to non-destructive testing and, more particularly, to a sensor array for non-destructively monitoring a structure to detect and/or characterize a structural event.

(2) Description of the Prior Art

The performance of modern-day military helicopters, missiles, tanks, aircraft, and other static or dynamic structures is critically dependent on the reliability of advanced composite materials and heterogeneous armor materials. There has been a reluctance to deploy such high performance materials in critical structural applications because of their susceptibility to in-service damage. The damage occurring in these materials may be difficult to track and can propagate quickly during operation of the vehicle or structure, resulting in the loss of the entire vehicle.

Conventional non-destructive evaluation techniques are labor intensive, expensive, error prone, and unworkable for efficient integration into composite and heterogeneous structures. Autonomous integrated Structural Health Monitoring (SHM) techniques are a revolutionary concept in the maintenance of structures. SHM techniques can continuously monitor the condition of a structure. Various approaches for SHM under development use piezoceramic sensors and actuators that require separate wiring connections for each sensor and actuator element, storage of pre-damage data for each sensor, and instrumentation for active generation and sensing of diagnostic signals. When the structural geometry is complex—e.g., either the structure has varying thickness, curvature, ribs, joints, or heterogeneous materials, or damage is located near boundaries of the structure—it may be difficult to detect small damage using SHM methods. In addition, the number of sensor circuits and computations required can increase the overall complexity and cost of the structure.

One approach to this problem is to integrate many fiber-optic strain gauges directly within the structural material. An optical fiber with twenty or more Bragg gratings can measure static and dynamic strains at discrete locations on the structure. An optical analyzer can multiplex over each fiber and each grating to measure strains at a large number of points on a structure. This approach is being implemented on bridges, pressure tanks and other structures. However, fiber optic sensors have limitations when applied to monitoring complex composite structures where damage can occur anywhere on the structure and in any direction. For example, discrete strain measurements can miss damage because the measurement is very localized at the fiber/grating. In addition, an optical analyzer using multiplexing and multiple connections is expensive; measurements are not simultaneous and the frequency bandwidth may be too low to sense Acoustic Emission (AE) signals.

AE sensors are presently suitable for detection of damage at “hot spots.” The use of AE measurements for SHM of large structures may have certain advantages since it is a passive sensing technique. Passive sensing methods may be simpler and may be more practical than using active interrogation methods. However, present passive acoustic emission and monitoring techniques can require bulky instrumentation with numerous channels, long connections, and centralized data analysis. It may be impractical to embed these systems on the structure to operate in the field. Another limitation is that AE waveforms from such sensors are too complicated for purposes of source characterization.

U.S. Pat. No. 6,399,939 issued Jun. 4, 2002 to Sundaresan et al. discloses a sensor array apparatus and method that can reduce the number of sensors and instrumentation channels required by an order of magnitude and retain the sensitivity in the high frequency range to detect incipient damage in the structure. The disclosure of U.S. Pat. No. 6,399,939 is hereby incorporated by reference in its entirety.

### SUMMARY OF EMBODIMENTS OF THE INVENTION

According to embodiments of the present invention, sensor assemblies for non-destructively monitoring a structure to detect a structural event include a plurality of sensor nodes configured to provide at least one sensor signal responsive to a structural event. A signal analyzer is configured to compare the sensor signal to a reference database of signal characteristics corresponding to respective structural events.

According to some embodiments, methods for non-destructively monitoring a structure to detect a structural event include receiving at least one sensor signal from a plurality of sensor nodes responsive to a structural event. The sensor signal is compared to a reference database of signal characteristics corresponding to respective structural events.

### BRIEF DESCRIPTION OF THE FIGURES

FIG. 1 is a block diagram of a sensor array including a plurality of discrete sensor nodes combined into a single output constructed according to embodiments of the present invention;

FIG. 2 is an enlarged block diagram of the signal processing module for the sensor array shown in FIG. 1;

FIG. 3 is a top elevation view of the PZT fiber sensor array having a plurality of discrete sensor nodes connected in series and combined into a single output according to embodiments of the present invention;

FIG. 4 is a simplified schematic of the bi-directional/single node PZT wafer sensor of the prior art, and the prior-art uni-directional/single node PZT fiber sensor shown in FIGS. 1 and 2;

FIG. 5 is a simplified schematic of the sensor array shown in FIG. 3 that includes a plurality of discrete sensor nodes combined into a single output according to embodiments of the present invention;

FIGS. 6A and 6B are graphs illustrating the effect of adding a plurality of discrete sensor node outputs into a single output;

FIGS. 7A and 7B are graphs illustrating the difference between the response of a conventional single node sensor and the response of a multi-node sensor, and their dependence on the location of the structural event;

FIG. 7C is a schematic diagram showing the positions of a sensor array embodiments of the present invention and a single sensor relative to acoustic emission events;

FIG. 8 is a schematic diagram of an alternative embodiment of the sensor array embodiments of the present invention, including a plurality of discrete sensor nodes combined into a single output;

FIG. 9 is a block diagram of a sensor array including a plurality of discrete sensor nodes combined into a single output constructed according to embodiments of the present invention;

FIG. 10 is a enlarged block diagram of the signal processing module for the sensor array shown in FIG. 9 which is modified from the signal processing module shown in FIG. 1;

FIG. 11 is a block diagram of a data collection system downstream from the signal processing module;

FIG. 12 is a schematic diagram of a continuous sensor array unit according to embodiments the present invention;

FIG. 13 is a schematic diagram of a plurality of sensor units connected to a sensor bus according to embodiments of the present invention;

FIG. 14A is a graph of a signal from a continuous sensor array according to embodiments the present invention;

FIG. 14B is a graph of a processed signal from a continuous sensor array according to embodiments the present invention;

FIGS. 15-17 are schematic diagrams of various modes of crack growth structural events according to embodiments the present invention;

FIGS. 18A-18B are schematic diagrams of a Mode I crack growth and sensor placements according to embodiments the present invention;

FIGS. 19A-19D are graphs of tangential and normal displacement from the sensors of FIGS. 18A-18B;

FIGS. 20A-20D are graphs of symmetric and anti-symmetric signals from the sensors of FIGS. 18A-18B;

FIGS. 21A-21D are graphs of wavelet maps using signals from the sensors of FIGS. 18A-18B;

FIGS. 22A-22B are schematic diagrams of a Mode I delamination crack growth and sensor placements according to embodiments the present invention;

FIGS. 23A-23D are graphs of tangential and normal displacement from the sensors of FIGS. 22A-22B;

FIGS. 24A-24D are graphs of symmetric and anti-symmetric signals from the sensors of FIGS. 22A-22B;

FIGS. 25A-25D are graphs of wavelet maps using signals from the sensors of FIGS. 22A-22B;

FIGS. 26A-26B are schematic diagrams of a Mode I delamination crack growth and sensor placements according to embodiments the present invention;

FIGS. 27A-27D are graphs of tangential and normal displacement from the sensors of FIGS. 26A-26B;

FIGS. 28A-28D are graphs of symmetric and anti-symmetric signals from the sensors of FIGS. 26A-26B; and

FIGS. 29A-29D are graphs of wavelet maps using signals from the sensors of FIGS. 26A-26B.

### DETAILED DESCRIPTION OF THE EMBODIMENTS OF THE INVENTION

Embodiments of the present invention will now be described more fully hereinafter with reference to the figures, in which embodiments of the invention are shown. Embodiments of the invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

Thicknesses and dimensions of some components may be exaggerated for clarity. It will be understood that when an element is referred to as being “attached”, “connected”, “interconnected”, “mounted” or “coupled” to another element, it can be directly connected or coupled to the other element or intervening elements may be present. In contrast, when an element is referred to as being “directly” connected, coupled, or the like, to another element, there are no intervening elements present.

Also in the following description, it is to be understood that such terms as “forward,” “rearward,” “left,” “right,” “upwardly,” “downwardly,” and the like are words of convenience and are not to be construed as limiting terms.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

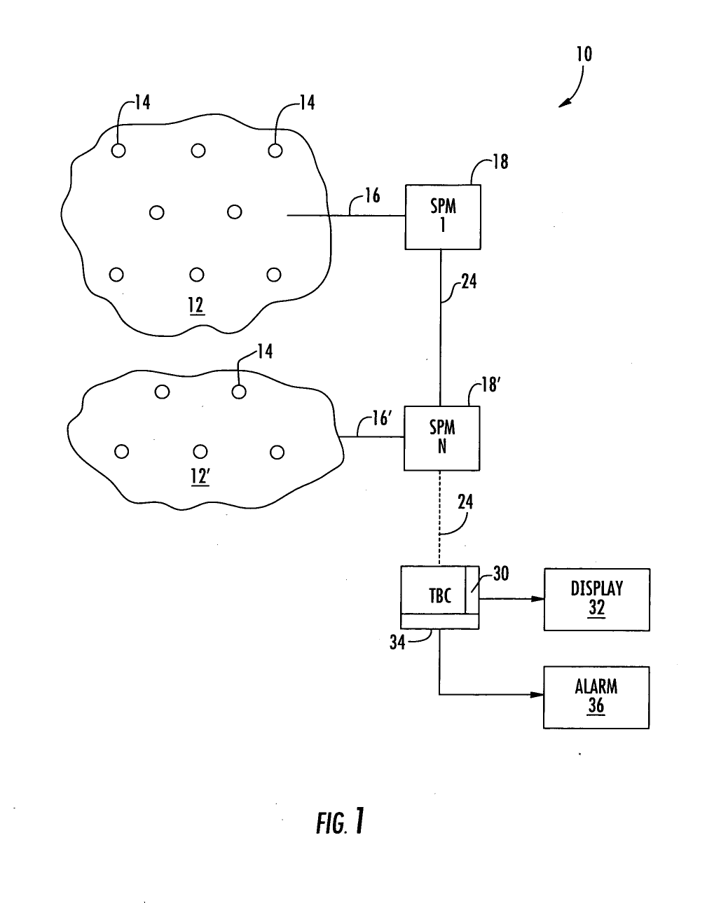

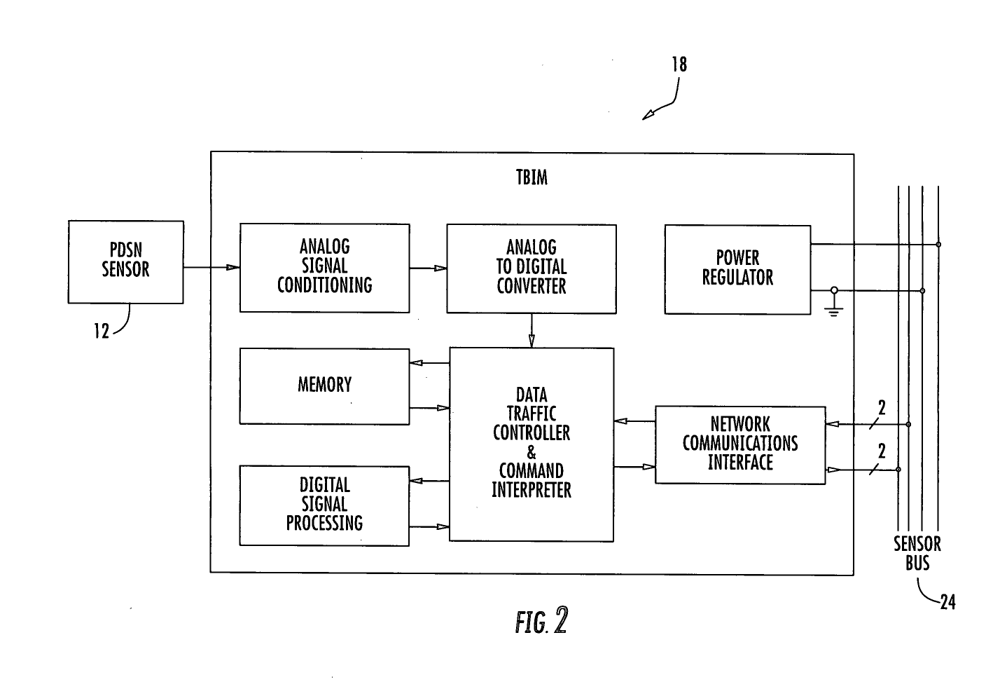

Referring to the drawings in general and FIG. 1 in particular, it will be understood that the illustrations are for the purpose of describing embodiments of the invention and are not intended to limit the invention thereto. As seen in FIG. 1, a sensor array, generally designated 10, is shown. The sensor array 10 includes three major sub-assemblies: a unit cell 12 having a plurality of discrete sensor nodes 14; a signal adder for combining the output of each of the discrete sensor nodes 14 into a single output 16; and at least one signal processing module 18. Similar signal processing/analyzing units are commercially available. Among the manufacturers of such units is Endevco Corporation, located in San Juan Capistrano, Calif. In some embodiments, the signal addition may be accomplished by electrically connecting the signals from the sensor nodes 14, for example, the sensor nodes 14 may be connected in series.

As seen in FIG. 2, an embedded electronic signal processing module 18 conditions the AE signal and performs the data processing and/or signal analysis. The signal processing module 18 is made of an analog ASIC (Application Specific Integrated Circuit), for analog signal conditioning, and a digital ASIC which performs the quantification, pattern recognition, timing, and short time data storage.

As seen in FIG. 1, a digital data bus 24 provides communication between the signal processing modules 18 and the CPU 30. Further, this bus also powers the signal processing modules 18. The Transducer Bus Controller (TBC) is located in the CPU 30.

The CPU 30 assembles the processed information sent by the sensor nodes 14, and assesses any damage growth that may be occurring in the structure. In some embodiments, the acoustic emission data processing takes place within the respective signal processing modules 18, and the processed information is communicated outward through the interface bus 24. Furthermore, the fibers are connected in either series, parallel, or a combined series/parallel configuration to tailor the sensitivity of the sensor nodes 14 and match the environmental conditions under which it is operating. Bi-directional communication between the signal processing modules 18 and the CPU 30 takes place over the single digital data bus 24, thus eliminating cumbersome cables.

In operation, the CPU 30 initializes all sensor nodes 14, including their short-term clocks. The CPU 30 then queries each sensor node at time intervals of the order of a few tens of seconds to download the gathered information. The signal processing modules 18 and the sensor nodes 14 perform the digitization and analysis of the AE signals and store in a tabular form within its memory only those processed data that are recognized as related to damage growth for uploading to the CPU 30.

Among the parameters stored in the signal processing modules 18 are the time of occurrence of the AE event, energy content of the AE event, and the amplitude, duration, pattern, and other relevant parameters of the AE signal envelope. The TBC addresses each signal processing module 18 sequentially to upload the processed information from the signal processing modules 18, 18′ permanently stored in CPU 30.

In this configuration, the sensor arrays 10 can be positioned on or adjacent a structure and the CPU 30 can characterize a structural events based on the signal output(s) 16. In some embodiments, the sensor arrays 10 are positioned above and/or below the structure. The signal processing module 18 can detect, identify and/or characterize structural events based on acoustic emission source mechanisms and the nature of stress wave signals produced in the structural member. A “structural event” is any event or change to the structure that results in a detectable acoustic emission signal. Examples of structural events are cracks or separations within the structure, such as transverse crack growth (referred to herein as “Mode I”) and delaminated crack growth (referred to herein as “Mode II”). A “mode” is a characterization of a type of structural event, for example, based on the direction of separation within a structure and/or the type of stress causing the separation. A transverse crack growth refers to a crack that extends substantially normal to a major surface of the structure, and a delaminated crack growth refers to a crack that extends substantially parallel to a major surface of the structure. Examples of various types of structural events are shown in FIGS. 15-17.

In some embodiments, experimental data and/or data obtained by computer modeling can be used to characterize the acoustic emissions signals. The characterization can be based on the amplitude of the signal, the frequency of the signal, and/or the type of wave form (e.g., sheer and/or transverse stress waves, symmetric and/or anti-symmetric signals, and/or wavelets of various types of signals). For example, a particular type of structural event can be initiated in a material and the resulting acoustic emissions signals can be analyzed. The acoustic emissions signals of different types of structural events can be compared to determine likely characteristics of a particular type of event. These characteristics can be stored in a reference database. Alternatively, a computer model can be used to determine the likely characteristics of signals corresponding to particular events in a structure. When a structural event of an unknown mode occurs, the event can then be identified based on the characteristics of known events. It should be noted that the signal characteristics may be dependent on the geometry of the particular structure being analyzed. Therefore, the reference database of signal characteristics may be structure specific.

The signals received by the signal processing module 18 can be analyzed and the structural events can be characterized based on the signal output(s) 16. For example, the approximate location of the structural event may be determined. That is, one or more combined signals output(s) 16 can be analyzed and various components may be separated into signals substantially corresponding to a signal detected by a particular node 14, for example, based on a time interval between sensor signals. As another example, the structural event may be characterized as to the size and or type of crack growth based on the signal output 16.

In some embodiments, the sensor nodes 14 can include sensors that are sensitive selectively to either normal surface displacement in the structure or tangential displacements in the structure. The differences in acoustic emission source mechanisms can be examined from the ratio of normal displacement sensor output and tangential displacement output. In addition, sensor nodes of the same category (e.g., either normal displacement sensors or tangential displacement sensors) can be positioned on opposite surfaces of a structure as illustrated in FIGS. 15-17. In this configuration, the signals from sensor nodes on opposite surfaces may be added, subtracted, and/or otherwise combined to extract symmetric and/or anti-symmetric modes of Lamb waves originating from structural events. The waveforms, symmetric and antisymetric components of the stress waves, wavelet maps of the signals, and the like may be used to analyze the frequency components present in the acoustic emission signals. For example, Mode I and Mode II crack growth generally exhibit differences in the frequency content of the symmetric and anti-symmetric components of the stress waves. The information related to the symmetric and anti-symmetric components of the normal and tangential displacements and their frequency content can be analyzed to identify the structural events and, in particular, to distinguish between various modes, such as Mode I crack growth and Mode II delamination crack growth. Normal and shear displacement sensors are commercially available from Panametrics-NDT, Waltham, Mass., U.S.A. Suitable bonded PZT sensors may also be used for sensing the normal and shear displacements.

As seen in FIG. 5, the collection of sensor nodes 14 forms a unit cell 12 of a ‘smart’ composite material. The sensor array 10 can be constructed by embedding tens or hundreds of these sensor nodes 14 in laminated composite or textile composite structures. In some embodiments, each of these sensor nodes 14 is formed from piezoceramic tapes whose segments act as independent sensor nodes 14 that detect damage to the structure by measuring AE waves generated by cracks in the material or breakage of fibers. The piezoceramic fibers can also potentially measure dynamic strains within the structure, which is useful for monitoring and regulating load paths within the structure to extend its safe life.

Active Fiber Composite (AFC) materials using PZT fibers (developed at MIT and commercialized by Continuum Control Corporation, Billerica Mass.) or ribbons (recently developed by CeraNova Corporation, Franklin Mass.) may be used to construct long continuous sensors. Interdigitated (IDT) electrodes are used to pole and electrically connect the sensor. The AFC may be thermally stable, have a long fatigue life, provide great flexibility in tailoring and designing a sensor material, and may be strong and rugged enough to be used on helicopters, in armor, and in layered composites. Because labor can be most of the cost of producing the sensor tape, the use of a single ribbon effectively replaces six circular fibers while still retaining the advantages of the fibers, and significantly reduces the cost of the distributed sensors.

Overall, the combination of fine piezoceramic fibers or ribbons with a flexible matrix provides a sensor material that may be more robust and may have a higher ultimate strain than the monolithic ceramics. The use of fibers or ribbons can retain most of the stiffness of monolithic piezoceramic patches, and the unidirectional alignment creates the desired sensing/actuation in a single direction. The active fibers and structural fibers can be mixed within a single ply or can form separate plies in a composite. The overall laminate properties are found by a layer-wise integration of the constitutive equations for the layers. These properties can be used in wave propagation simulations to determine the dynamic response of the sensor composite.

The electrode configuration can be designed to pole the fibers axially or through their thickness. Thin foil conductors (IDT electrodes) oriented perpendicular to the fibers are used on the top and bottom of the fibers. The conductors are used for both electroding and poling. The advantages of these designs are: (a) if the sensor is poled through the thickness of the fibers, the electrodes are easy to manufacture; (b) non-conductive structural fibers can be mixed with the sensor fibers, or conductive fibers can be put in adjoining layers; (c) the sensor can measure dynamic strains above 0.5 Hz.; (d) the sensor can be one cell of the system and AEs can be detected from all segments simultaneously; (e) the electrodes are deposited directly on the active fiber for ease of manufacturing and to allow a higher signal output when operating in the low field range; (f) ribbons which are larger than fibers and easier to fabricate can be used instead of fibers, making electroding easier and polarization more uniform; and (g) once encapsulated in a matrix, the ribbon can be woven as a straight fiber into textile composites. Both transverse and axial poling concepts are possible. In conventional AFCs, the electrodes are placed on the matrix above the fibers to prevent concentrations of the electric field in the fiber that can lead to locally high strains and fiber breakage. Because the fibers are being used for sensing and not actuation, fatigue due to high electric field concentrations that normally necessitates use of the electroding above the fibers may be reduced. The electrodes can be used for directly poling the sensor material.

As seen in FIG. 4 and FIG. 5, the initial modeling that was performed to study the composite couples the elastic equations of a bar or plate structure to the piezoelectric constitutive equations and a parallel tuning electric circuit.

The piezoelectric equations to model a PZT or AFC sensor are:

$$[ \begin{matrix}D \\ T\end{matrix} ] = [ \begin{matrix}{ɛ}^{S} & e \\ - {( e )}^{t} & {c}^{E}\end{matrix} ] [ \begin{matrix}E \\ S\end{matrix} ] \qquad ( 1 )$$

where D is the electric displacement in coulombs/m², T is the stress in N/m², E is the electric field in volts/m, S is the strain, ∈^{s} is the clamped dielectric in Farads/m, e is the induced stress constant in Coluomb/m² or equivalently N/(m*volt), t is transpose, and c^{E} is the constant field stiffness in N/m².

Considering a single axis, the equations in (1) are represented as:

$$\begin{matrix}{D}_{j} = ( {ɛ}^{S} E ( t ) + e \frac{\partial w ( {x}_{j} , t )}{\partial x} ) sgn ( j ) & ( 2 ) \\ {i}_{gj} = [ {C}_{j} {\dot{V}}_{o} / K + e \frac{{\partial }^{2} w ( {x}_{i} , t )}{\partial x \partial t} ] {A}_{c} sgn ( j ) & ( 3 )\end{matrix}$$

where j represents the jth segment of the sensor, w is the longitudinal displacement, V is the voltage, C is the capacitance of the piezocerainic, and the sgn function allows connection of the segments with positive or negative polarities. An electric circuit representing equations (2-3) for series connectivity is shown in FIG. 5.

An electrical parallel tuning circuit is connected to the acoustic emission sensor circuit to filter out the ambient vibration response to more accurately sense the acoustic emissions from cracks.

The combined equations for the electrical model of the AFC sensor and the connected tuning circuit are:

$$[ \begin{matrix}{L}_{s} & 0 \\ - {L}_{p} & {L}_{p}\end{matrix} ] [ \begin{matrix}{\ddot{i}}_{l} \\ {\ddot{i}}_{s}\end{matrix} ] + [ \begin{matrix}{L}_{p} / ( {R}_{p} {NC}_{p} ) & 0 \\ 0 & {R}_{s}\end{matrix} ] [ \begin{matrix}{\dot{i}}_{l} \\ {\dot{i}}_{s}\end{matrix} ] + [ \begin{matrix}1 / ( {NC}_{p} ) & 1 / ( {NC}_{p} ) \\ 0 & 1 / {C}_{s}\end{matrix} ] [ \begin{matrix}{i}_{l} \\ {i}_{s}\end{matrix} ] = - \frac{{A}_{e} e}{{NC}_{p}} [ \begin{matrix}{\sum }_{j = 1}^{n s} {w}_{xt}^{j} sgn ( j ) \\ 0\end{matrix} ] \qquad ( 4 )$$

where is and il are the currents in the tuning circuit, R, L, Cₛ are the circuit parameters, Cₚ, Aₑ, e are the sensor piezoceramic material parameters, and N, wₓₜ^{j}, sgn(j) are the number of sensor nodes, the strain rate at node j, and sign of the connectivity of node j.

An elastic model of a bar or plate is used to simulate the response of the sensor material subjected to AE or other excitation. The plate with the segments is shown in FIG. 7. The segments S1, S2, S3, S4, . . . S16 model the sixteen sensor segments of one fiber tape in the composite shown in FIG. 1. Since the AFC is poled using the electrodes, each segment acts as a uniform sensor. The segments can be spaced and connected in alternating polarity to cancel low frequency (<100 KHz) structural vibrations and the length of the segments can be matched to the half wavelength of the dominant stress waves to be measured.

This approach uses the continuous nature of the sensor as a spatial filter to cut-off the low frequency response that masks the AE response. If small segments are used, the continuous sensor can be designed similar to an acoustic wave filter to measure Lamb waves produced from damage propagation. Organic composites produce extensive AEs in the presence of damage. Thus, monitoring of AE in composites can be used as a passive method for damage detection. AEs in thin composite structures propagate as Lamb or plate waves. The two plate modes of AE waves observed in AE signals are the symmetrical, or extensional, wave and the anti-symmetric, or flexural, mode. Extensional plate waves contain higher frequency components and occur first in the signal, whereas the flexural waves contain lower frequency components, have higher amplitudes, and occur later in the wave.

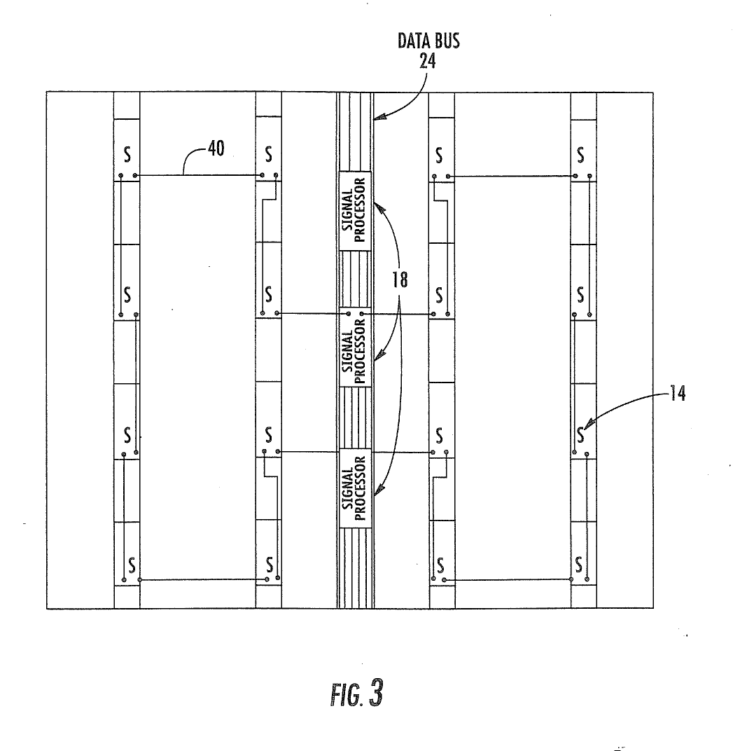

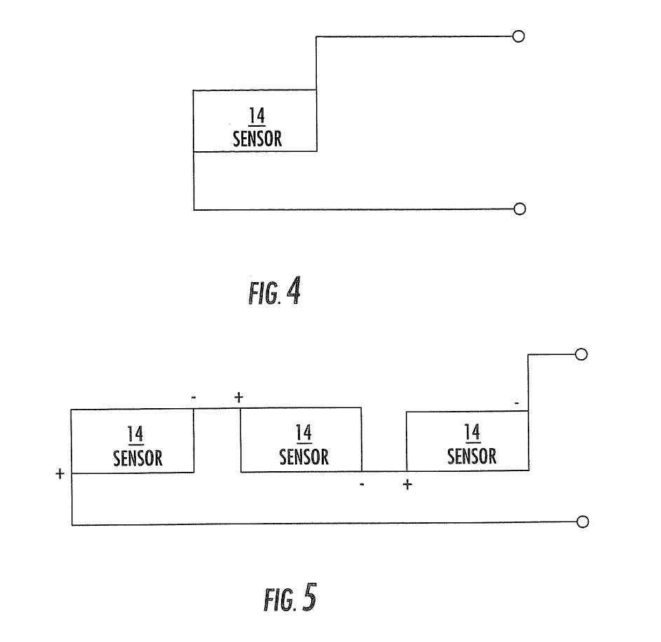

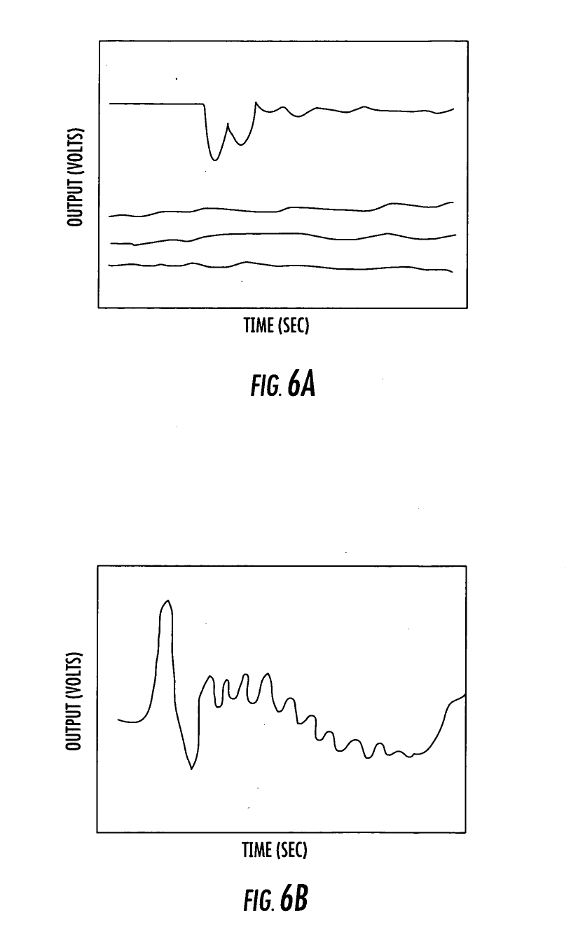

As seen in FIGS. 6A and 6B, experiments have been performed to verify the characteristics and potential of the continuous sensor material. An AE event was simulated by breaking a pencil lead near sensor 1, and AE waveforms corresponding to four sensors were recorded using a digital oscilloscope, as shown in FIG. 6A. Sensor 1, which was nearest to the simulated AE source, registered the highest signal magnitude, and, more significantly, had higher frequency components present in the signal. Sensors 2, 3 and 4 had progressively fewer high frequency components in the signal, because high frequency components attenuate as a function of distance traveled more rapidly than low frequency components. Frequency components above 100 kHz were almost totally absent in these three sensors.

In practice, frequency components that are higher than 100 kHz can provide valuable information about the AE source. Obtaining those frequency components, however, would require a large number of AE sensors to monitor most structures. The weight, cost, and complexity of such a multi-channel instrument may be prohibitive.

Next, a distributed sensor was formed by connecting the four sensors to a single channel of a digital oscilloscope. A signal was generated by breaking a pencil lead near sensor 1. The signal detected from this arrangement is shown in FIG. 6B. The response of the continuous sensor was reduced in amplitude, but the high frequency components were preserved intact and the amplitude levels were still adequate for AE sensing. As seen in FIGS. 7A and 7B, the output of a continuous sensor array 10 was compared to that of a single PZT sensor 11 for detecting an acoustic emission on a fiberglass panel, shown in FIG. 7C. A pencil lead break at location A in FIG. 7C is detected by both the continuous sensor array 10 and the conventional sensor 11. In contrast, the sensor response due to a pencil lead break at location C in FIG. 7C shows that the continuous sensor array 10 captures the signal while the conventional sensor 11 at CS cannot sense an AE signal that is originating at a point distant from the sensor.

In operation, the continuous highly distributed sensor system can monitor entire structures with a single digital data bus 24 and can thus eliminate the bulky coaxial cables and greatly reduce the hardware and communication needs for a field deployable health monitoring system. To illustrate this, consider an AE event occurring at a random location along a straight-line segment of length L, while this segment is monitored through N equally spaced AE sensors. The maximum distance that the AE signal travels to reach the closest sensor is d=L/(2N). The number of sensors required would be determined by the exponential rate of attenuation of AE voltage signals given by V=Aₒe^{-Kd}/N^{a} where Aₒ is a signal amplitude coefficient, a is an exponent, and K is a material-dependent decay constant. The sensor array is able to minimize the exponents d and a in the above equation, thereby maximizing the possibility of detecting an acoustic event.

In order to train the sensor network, a procedure of calibrating each unit cell can be established. Although the different unit cells attached to a structure may be similar to each other, the dynamics and wave propagation characteristics may vary from point-to-point on the structure. Unless each signal processing module takes these differences into account when reducing the data, errors can be introduced in the quantification of the AE activity. The calibration procedure could establish the threshold levels, data acquisition time window, and other related parameters.

The software in the CPU 30 may be robust enough to identify the failure of a sensor or signal processing module 18. Redundancy can be built into the sensor network, such that most damages will be detected by more than one unit cell.

Among the advantages provided by the sensor array 10 are: (i) a drastic reduction of the weight, cost, and complexity of instrumentation; (ii) increased probability of detection of the acoustical event due to the reduction in the source-to-sensor distance; and (iii) a more faithful retention of the acoustical signature, including the high frequency components, of the source event in the signal transmitted from the distributed sensor, due to minimization of the source-to-sensor distance.

Since the high frequency components of an AE signal may attenuate much faster than the low frequency components, the signal from the sensors will have little resemblance to the source event if the travel distance d is long. Conventional AE techniques quickly become impractical for most field-deployable health monitoring applications, as they require as many independent data acquisition channels as the number of sensors.

With the active composite continuous sensor described herein, an entire structure can be monitored by a group of continuous sensors or unit cells with N sensing elements, all connected to a single digital data acquisition bus. By increasing the number of sensor elements, it is possible to have access to the leading edge of the AE waveform before it is dispersed. Such access may be used to identify the source mechanisms and to estimate the source magnitude. The AE source can be located within the region of a given distributed sensor and network algorithms will be developed to locate the damage more precisely for subsequent closer inspection and repair.

Certain modifications and improvements will occur to those skilled in the art. By way of example, the electrode pattern—specifically, the width and spacing of the AFC sensor segments—can be designed to increase the voltage and current output of the sensor for a particular application. Transverse electroding and poling can be used instead of interdigital electrodes and can simplify the design and reduce the cost of the AFC sensor segments.

The continuous sensor segments can also be connected in four possible combinations to tailor the sensor characteristics, such as signal level and spatial filtering, for specific applications. The four combinations are: (i) an aligned series connection—i.e., (+−)(+−)(+−)(+−) . . . ; (ii) an alternating series connection—i.e., (+−)(−+)(+−)(−+) . . . ; (iii) an aligned parallel connection in which all positive terminals are connected to a common positive point and all negative terminals to a separate, common negative point; and (iv) an alternating parallel connection in which the parallel connection for the adjacent sensor nodes are reversed. A specific example is illustrated in FIG. 8.

Besides acoustic emissions, the sensor array can measure different events-including peak strains, peak vibration levels, and stress wave propagation from impacts on the structure—that are pertinent to structural health monitoring. The large area coverage and simultaneous sensing can localize the event to a particular unit cell. The sensor array can be configured for integration into composite materials or attachment to the surface of metallic structures such as an aircraft. By having segments of the sensor array connected with different directional sensitivity, the unidirectionality of the active fiber composite sensor material can also be used to determine the location of events.

The individual sensor elements or nodes may also include an addressable switch that can be used to include or exclude that sensor element from the network of the sensor, thus providing a self-configuring sensor continuous sensor that can automatically adapt to operating conditions. The local processor can have the ability to address the switch and to configure the network of sensors to be employed at a given stage to monitor structure health. Communication between the local processor and the individual sensor nodes is established by either a local digital data bus or the signal leads.

As seen in FIG. 9, a sensor array, generally designated 110, is shown. The sensor array 110 includes three major sub-assemblies: a unit cell 112 having a plurality of discrete sensor nodes 114; a signal adder for combining the output of each of the discrete sensor nodes 114 into a single output 116; and at least one signal processing system 118a. The signal processing system(s) 118a are connected to a data collection system 150 by a bus 148.

The plurality of discrete sensor nodes 114 may further be divided into discrete subgroups, each of the discrete subgroups located at a different structural location. The plurality of discrete sensor nodes 114 are electrically connected in series thereby forming a continuous series connection between each of the discrete sensor nodes.

A number of sensor node configurations are possible, for example, each of the discrete sensor nodes may include a chemical sensor or an accelerometer or a piezoceramic sensor. In some embodiments, the piezoceramic sensor further comprises a plurality of piezoceramic fibers arranged in a planar array wherein the piezoceramic fibers are aligned substantially parallel to each other.

In some embodiments, the signal output 116 and the signal processing system 118a are connected in series. In addition, the apparatus may further including a signal amplifier 138, such as an impedance matched amplifier, connected between the signal output 116 and the signal processing system 118a. Further, the apparatus may include a plurality of individual node signal amplifiers 140 connected between each of the discrete sensor nodes 14 and the signal processing system 118a. In some embodiments, each of the node signal amplifiers 140 also is an impedance matched amplifier. Also, the sensor array may further include a guard array such as a guard ring 128 for improving signal quality.

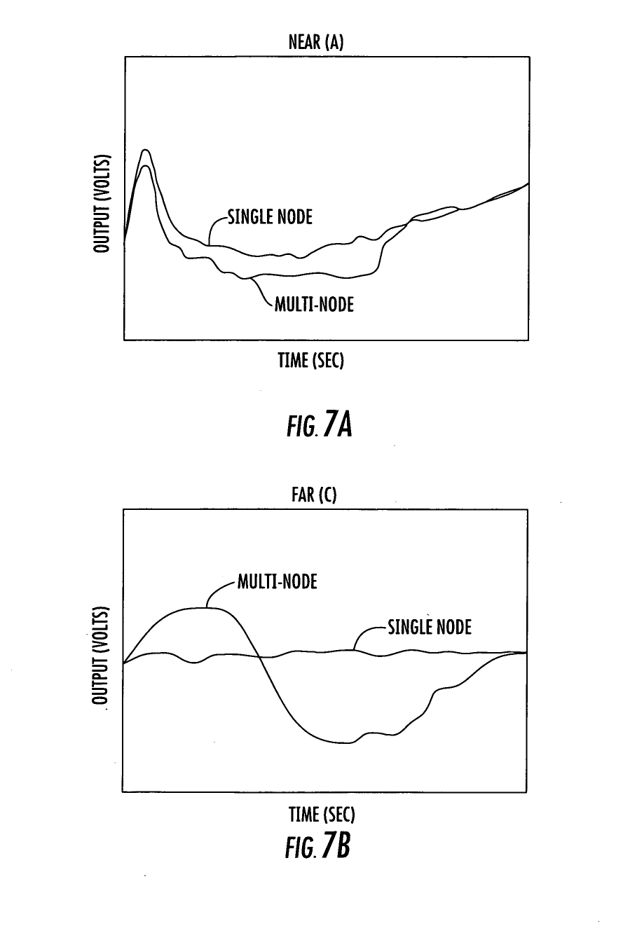

According to embodiments of the present invention, signal processing system 118a uses the time interval between the electrical signals from each of the discrete sensor nodes 114 formed into a single sensor array output signal 124 to calculate the location of the structural event. As seen in FIG. 10, the signal processing system 118a includes an input I, a filter 158 and an output O on a timed scale to calculate the location of the structural event. The filter 158 can be at a predetermined band width. In some embodiments, the filter 158 can filter noise from the signal.

The predetermine band width is determined according to algorithms described in Sundaresan, M. J., Schulz, M. J., Ghoshal, A., “Linear Location of Acoustic Emission Sources with a Single Channel Distributed Sensor,” Vol. 12, No 10, pp 689-700, October 2001, Journal of Intelligent Material Systems and Structures, the disclosure of which is hereby incorporated by reference in its entirety.

The signal processing system 118a conditions the AE signal and performs the data processing. The signal processing system 118a itself is made of an analog ASIC (Application Specific Integrated Circuit), for analog signal conditioning, and a digital ASIC which performs the quantification, pattern recognition, timing, and short time data storage.

Using conventional techniques, locating damage on a bar generally uses a minimum of two independent signal processing instrumentation channels, and locating damage on a plate generally uses a minimum of three such instrumentation channels. Thus, when multiple regions of complicated structures such as bridges, aircrafts, and space structures are to be monitored, the number of channels of instrumentation required for this approach may become numerous.

According to embodiments of the present invention, a single channel of AE instrumentation may be sufficient for identifying and/or locating the AE source within a region since the output on a timed scale is used to calculate the location of the structural event. Accordingly, instrumentation complexity, cost, and weight can be reduced by at least an order of magnitude, compared to conventional techniques.

As seen in FIG. 11, the data collection system 150 includes a plurality of various modules for recording and reporting events such as a signal analyzer 156 and a signal characteristics database 152. The signal analyzer 156 includes an exception reporting module 154 and a structural event identifier 160. The database 152 includes characteristics of signals associated with various types of structural events. The structural event identifier 160 compares a signal to the database 152 to determine if the signal matches characteristics for a known type of structural event in the database 152. In some embodiments, the filter 158 identifies signals that do not match the characteristics of a known type of structural event as noise. The database 152 may include signal characteristics of known structural events that are based on experimentally determined data and/or computer modeling. For example, the information in the database may be used to identify a direction and/or degree of structural separation and/or a physical location of an event.

In some embodiments, the exception reporting module 154 includes means for setting a predetermined threshold value and means for sending an alarm when the predetermined threshold value is met. Exception reporting module 154 may further include a station identifier for identifying the location of the alarm. For example, if the acoustic emissions signal indicates a structural failure, the exception reporting module 154 may initiate an alarm.

Although embodiments according to the invention are described with respect to the data processing system 118a and the data collection system 150, it should be understood that other configurations may be used. In particular, the functionalities described herein may be performed by either the data processing system 118a or the data collection system 150. For example, the data processing system 118a may include the signal analyzer 156 and the data collection system 150 can include the filter 158.

In operation, three or more piezoceramic (PZT) sensors, PVDF sensors, or other poled capacitive sensors are connected in series and attached to the structure. The output of these sensor nodes 114 are processed so as to extract specific modes of the Lamb waves that are propagating in the structure. After this processing, the signals corresponding to the signal arrival at each of the nodes of the continuous sensor are clearly separated. Further, by using the time interval between the signals from individual nodes, the location of the damage is calculated. The same procedure can be adopted for locating the damage in a plane by using a continuous sensor with a minimum of four sensor nodes. This procedure alone or in combination with neural network algorithm can be used for locating the damage and determining the severity of the damage event.

Thus, according to embodiments of the present invention, the number of channels of acoustic emission instrumentation channels required for identifying and/or locating the AE source in a planar structure is reduced from three in the current techniques to one when the time scale algorithms are used for planar AE source location. Also, the number of channels of instrumentations for locating an AE source along a line, such as a pipe, is reduced from two channels to one channel. As a result, a significant reduction in the cost of onboard instrumentation becomes possible. Moreover, structural events may be characterized, such as by determining the location of an event and/or the mode of the event.

With reference to FIG. 12, a unit cell 210 is shown. The unit cell 210 includes two types of sensor nodes, “S” or shear/tangential displacement sensors 214 and “N” or normal displacement sensors 215. The sensors 214, 215 are electrically connected in series to one another to provide a single output signal 216.

Although the unit cell 210 of FIG. 12 is illustrated as having shear/tangential displacement sensors 214 and normal displacement sensors 215, it should be understood that only shear/tangential displacement sensors 214 or only normal displacement sensors 215 may be used.

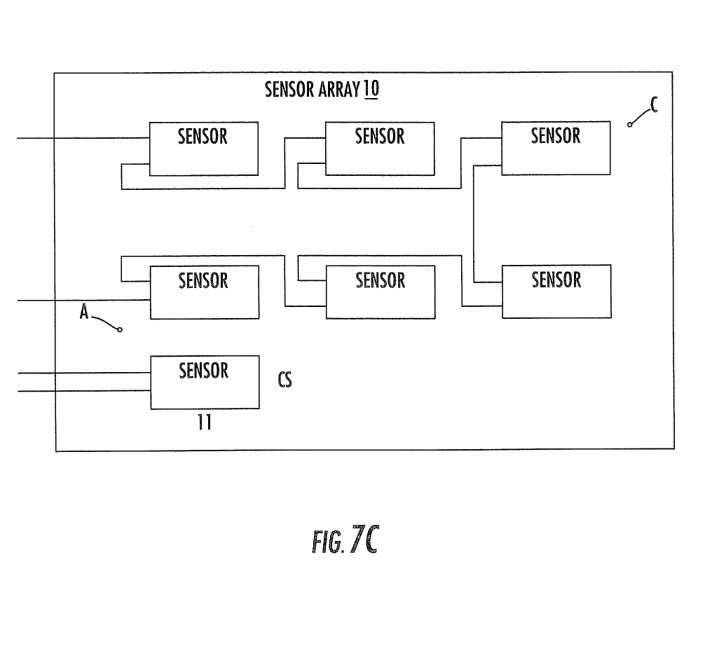

As shown in FIG. 12, the signal 216 is received by a processor 218. As illustrated in FIG. 13, a plurality of unit cells 210 and processors 218 are connected by a data bus 224, such as a digital data bus, which is in turn connected to a bus controller 230 and a central controller 234. The sensors 214, 215 can be connected in series or in parallel as shown in FIG. 13. The bus controller 230 receives signals from the data bus 224 from the unit cells 210, and the central controller 234 analyzes the signals to characterize structural events as described herein. In some embodiments, unit cells 210 are placed on opposite sides of a structure and/or embedded in a composite structure or bonded on the surface of a metallic structure.

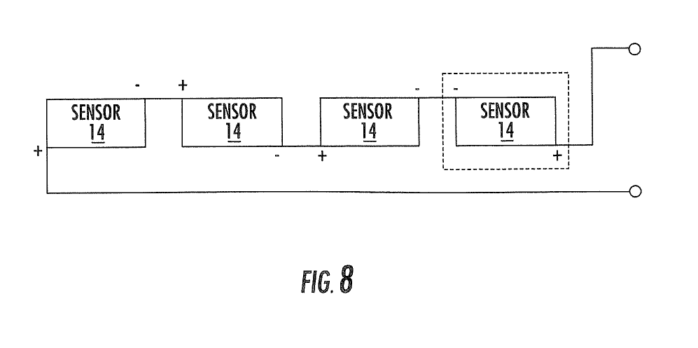

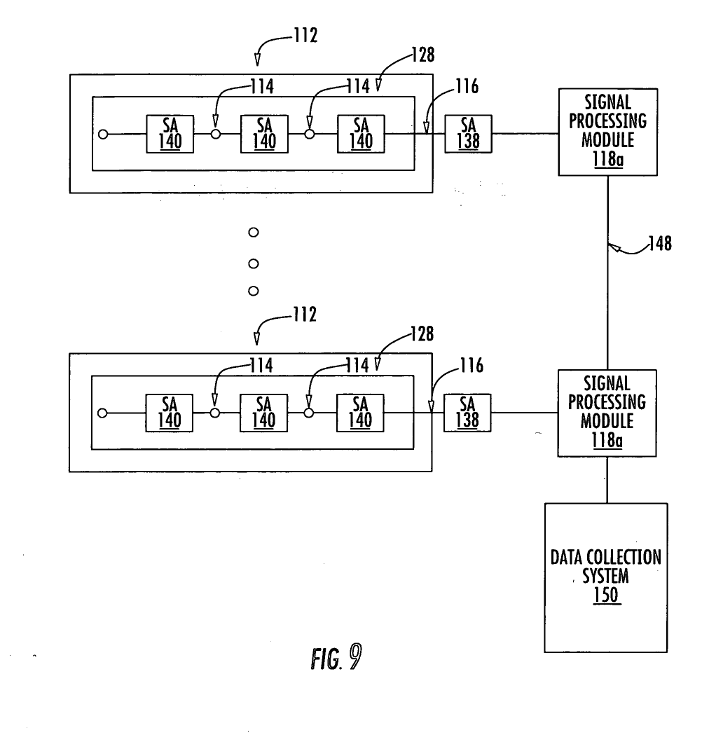

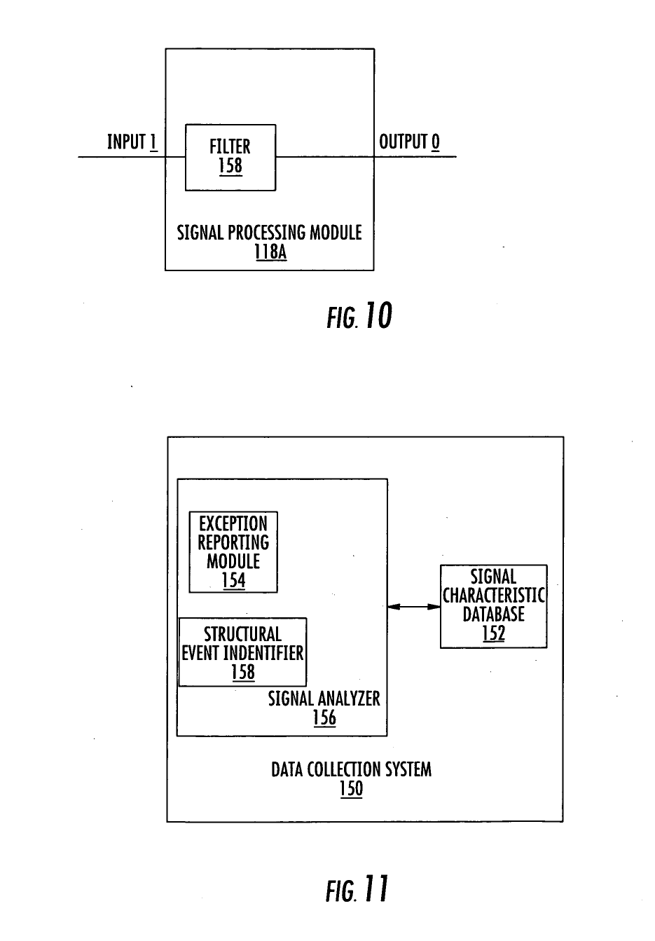

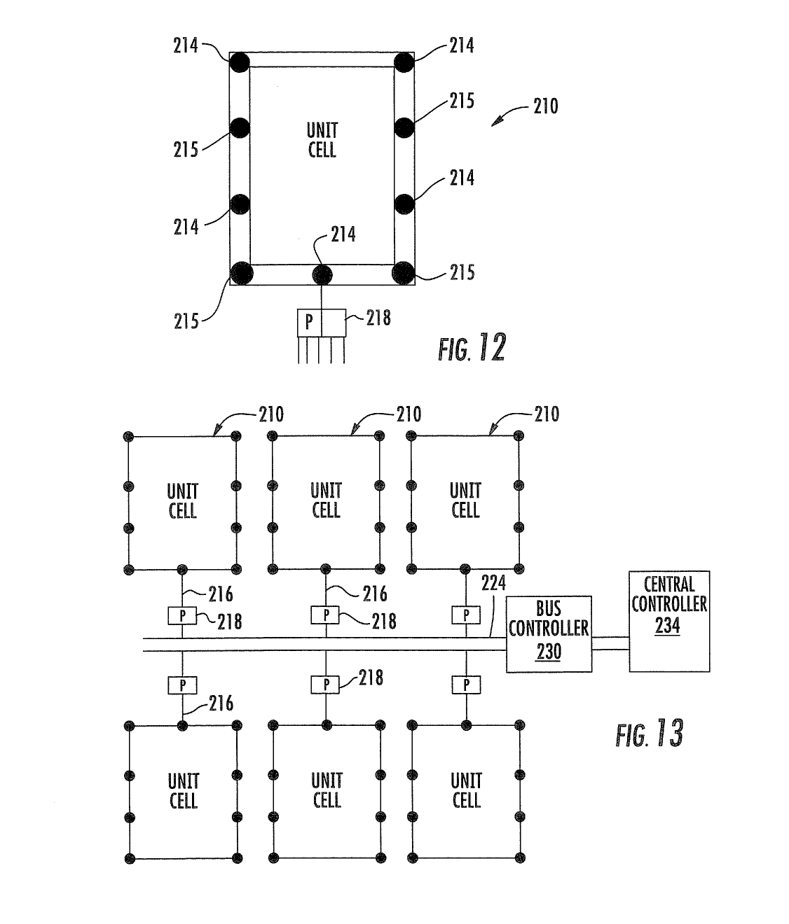

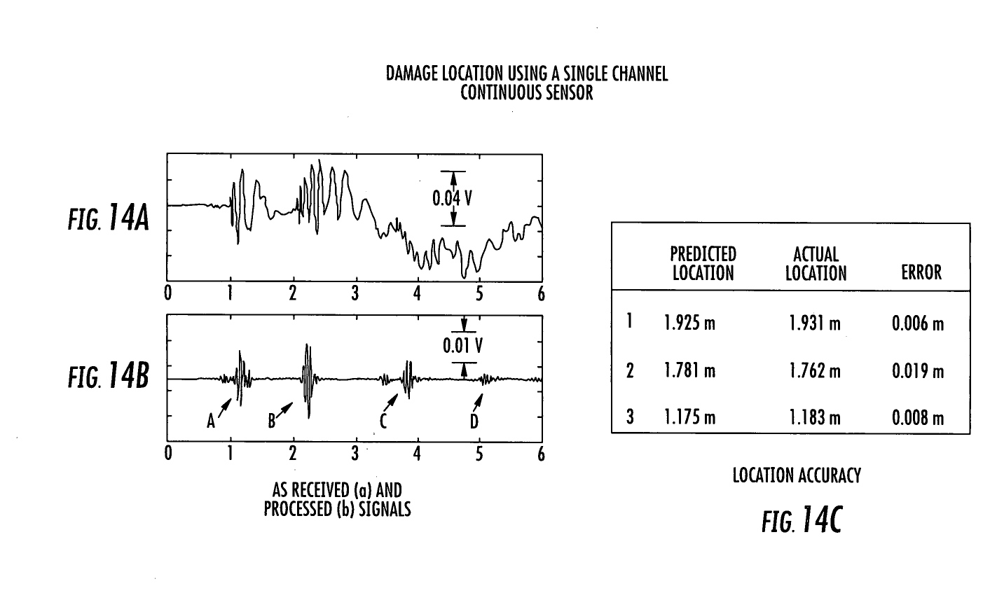

A signal, such as signal 216 received from a unit cell 210, is illustrated in FIG. 14A. The signal can be analyzed to isolate a narrow band nondispersive component of the stress wave as illustrated in FIG. 14B. As shown in FIG. 14B, the signal includes four general components A, B, C and D, which correspond to an event received by individual nodes 214, 215. The timing difference between the components A, B, C and D, can be used to determine the approximate location of the structural event as shown in FIG. 14C using the techniques described herein.

Examples of embodiments according to the present invention are provided by the following non-limiting example.

### Example

As illustrated in FIGS. 18A-18B, a glass/epoxy composite laminate (L) is instrumented with two normal displacement sensors N1, N2 and two shear/tangential displacement sensors S1, S2 positioned on opposite sides thereof. The laminate (L) is one inch wide, 0.125 inches thick, and sixteen inches long. A Mode I crack through the thickness of the laminate (L) as shown in FIG. 15 and a Mode II delamination crack as shown in FIG. 17 were initiated. Although the sensors N1, N2, S1, S2 are illustrated as individual nodes, it should be understood that unit cells, such as cells 10 and 110, may be used.

With respect to the Mode I crack, a 0.125 inch long edge notch was used to initiate a fatigue crack. The growth of the Mode I crack was monitored under constant amplitude cyclic load. With respect to the Mode II delamination crack, a delamination was created between the plies at approximately mid-thickness. This delamination specimen was also subjected to axial cyclic load and the growth of the Mode II delamination crack in the matrix/interphase was monitored using the sensor arrangement shown in FIGS. 18A-18B.

Normal sensors N1 and N2 may be 5 MHz damped ultrasonic longitudinal wave sensors, and shear sensors S1 and S2 may be 5 MHz damped shear wave sensors. These sensors N1, N2, S1, S2, may have relatively flat frequency response in the range of interest. The longitudinal normal sensors N1, N2 are generally sensitive to particle displacements normal to the plane of the laminate (L), and the shear wave sensors S1, S2 are generally sensitive to tangential displacements on the laminate (L) surface. It should be understood that the sensors N1, N2, S1, S2 may be positioned in alternative configurations that can be bonded to the surface of the specimen or embedded in a composite laminate. In addition, the sensors of the same type (i.e., shear or normal sensors) are attached on opposite surfaces of the laminate (L) at the same axial location so as to resolve the symmetric (e.g., N1+N2) and the anti-symmetric (e.g., N1−N2) components of the propagating acoustic emission wave. Suitable configurations of bonded PZT wafer or AFC sensors and/or commercially available acoustic emission sensors may also be used. The signals from the sensors S1, S2, N1, N2 were amplified by 34 dB and digitized at 50 million samples per second. The digital signals were further processed to obtain wavelet maps.

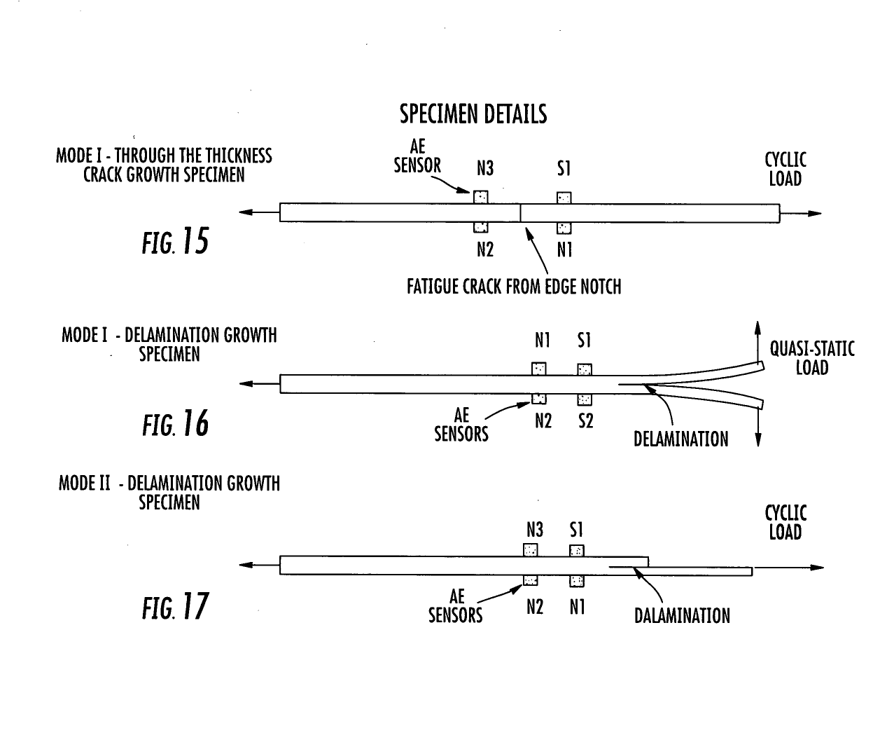

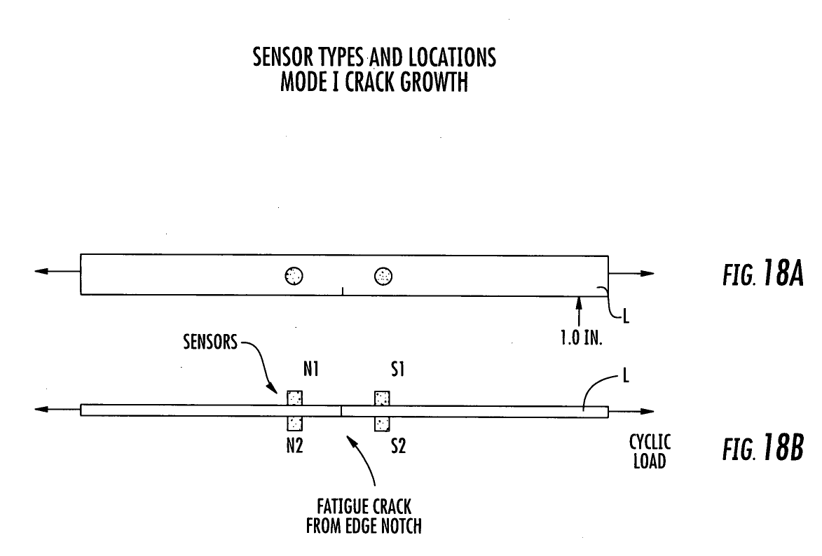

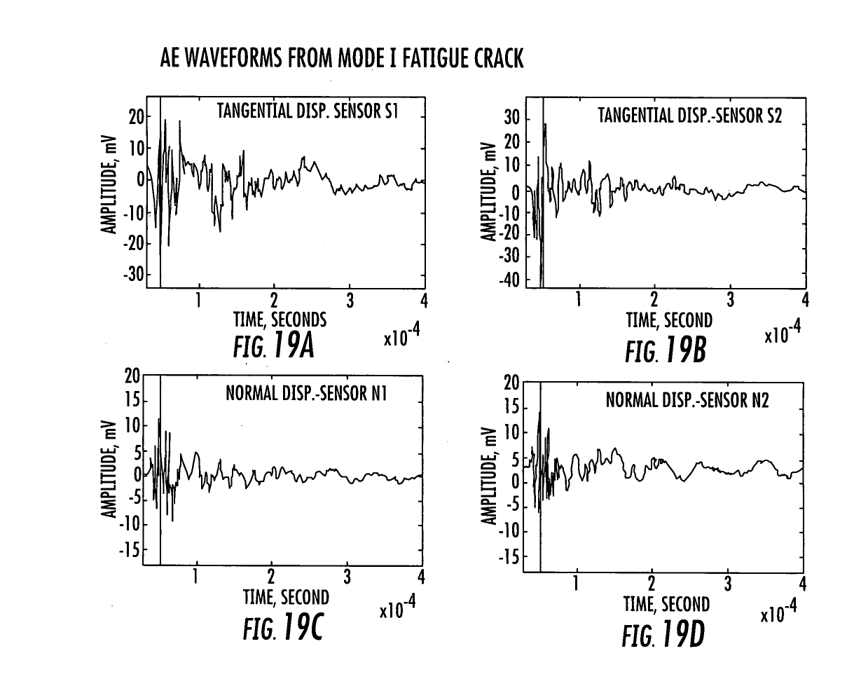

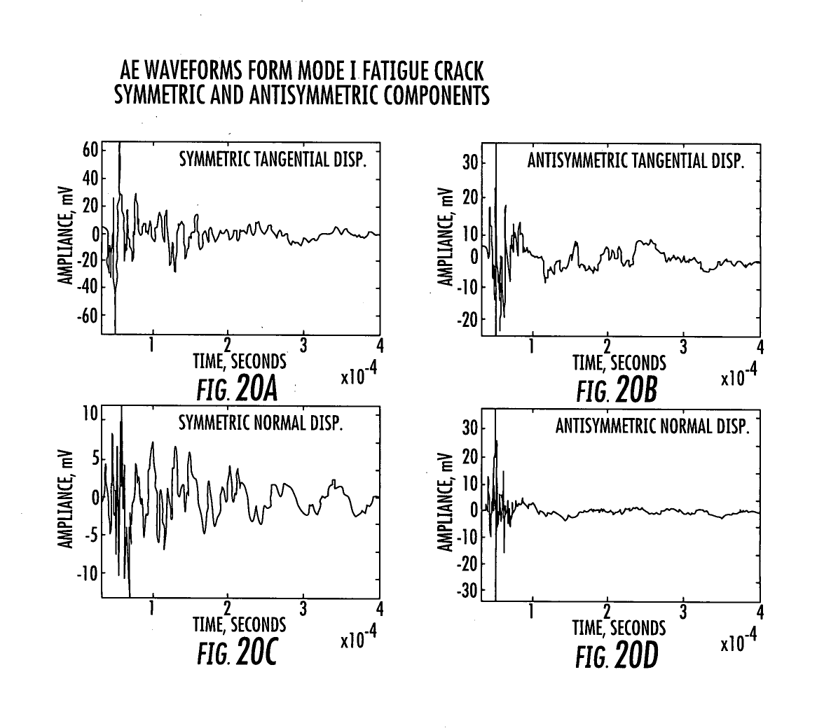

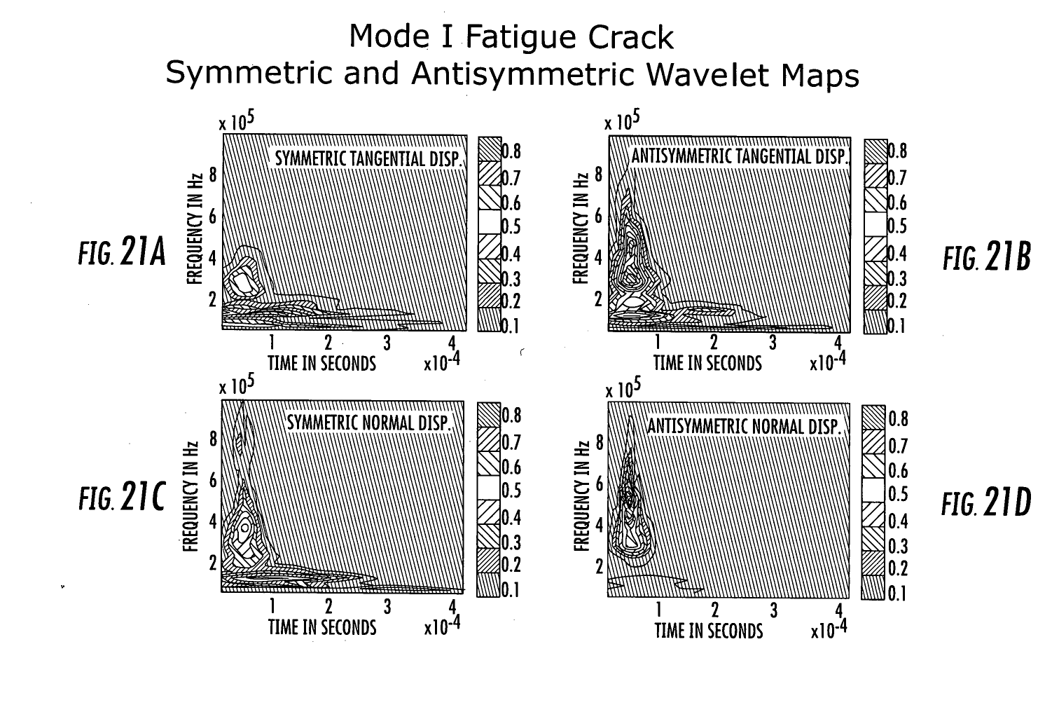

The acoustic emission waveforms from the Mode I fatigue crack of FIGS. 18A-18B are illustrated in FIGS. 19A-19D. The corresponding symmetric and anti-symmetric tangential and normal displacement components are illustrated in FIGS. 20A-20D. The symmetric and anti-symmetric wavelet maps are shown in FIGS. 21A-21D.

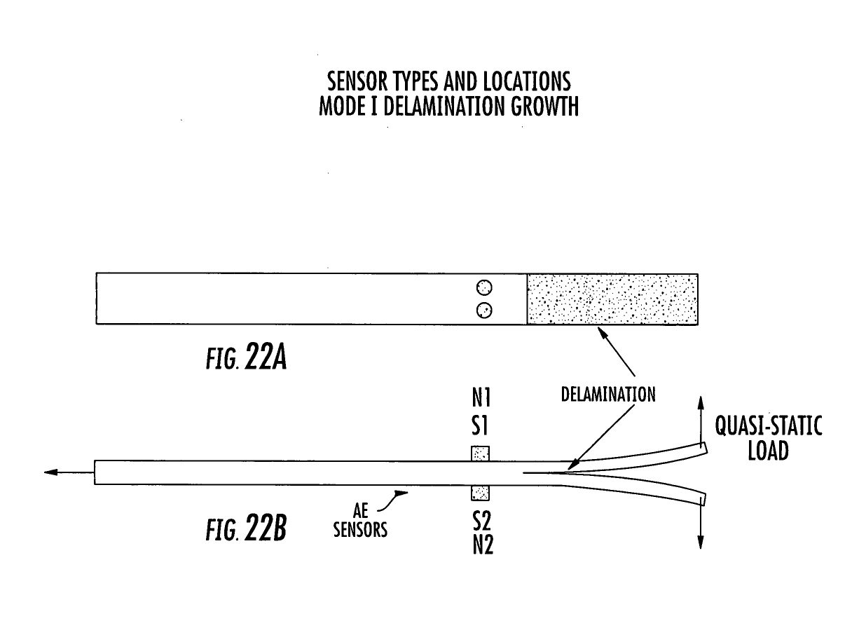

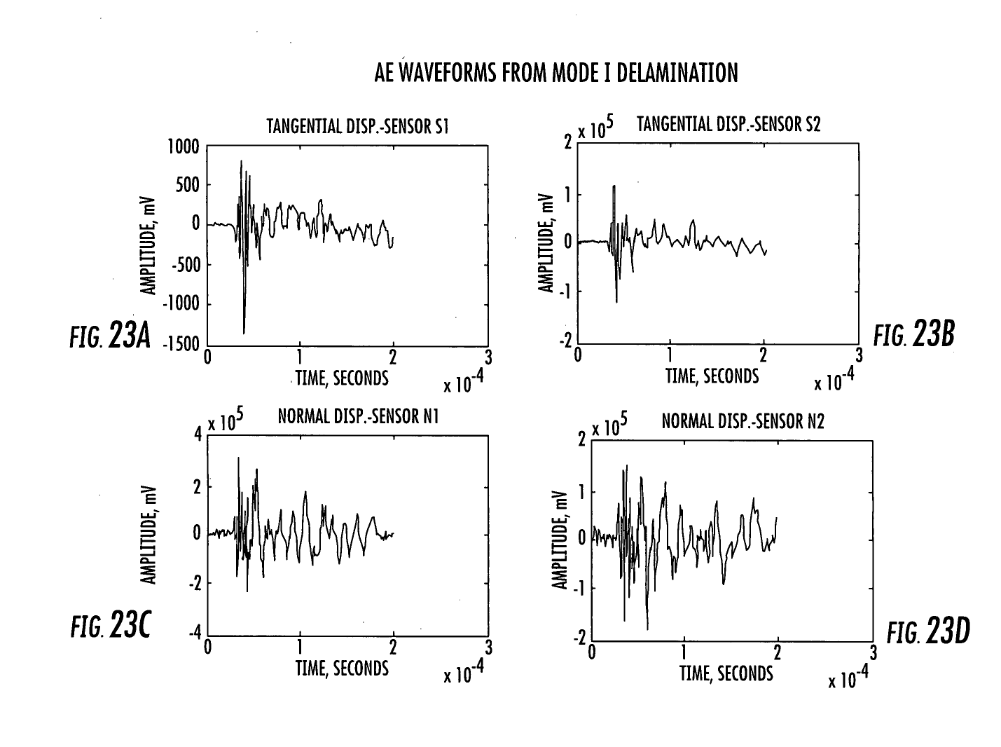

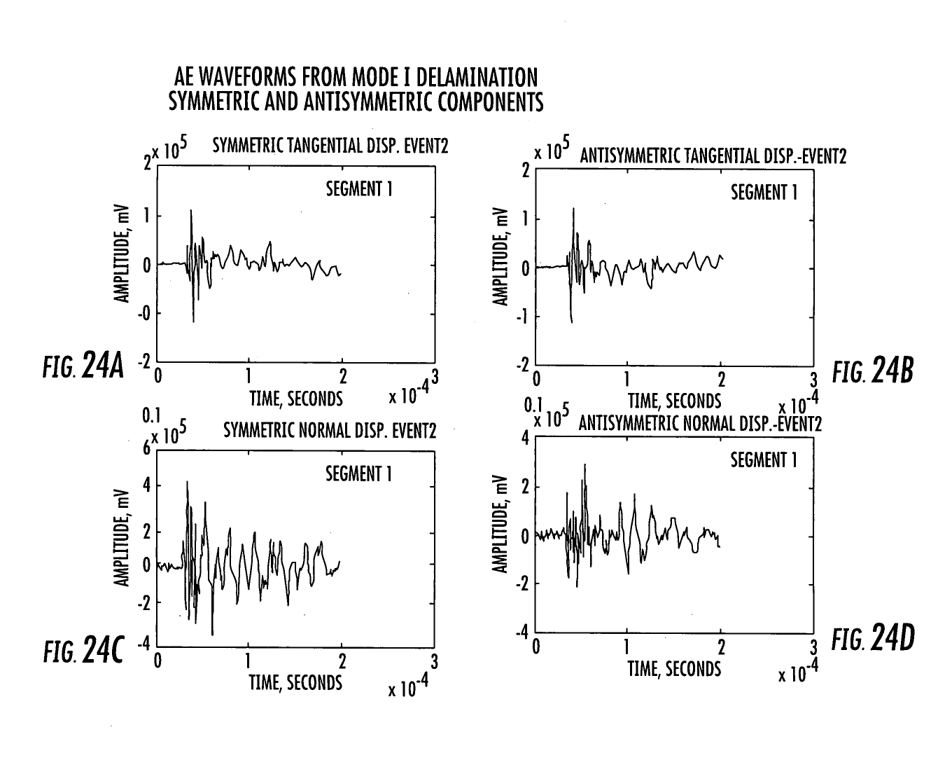

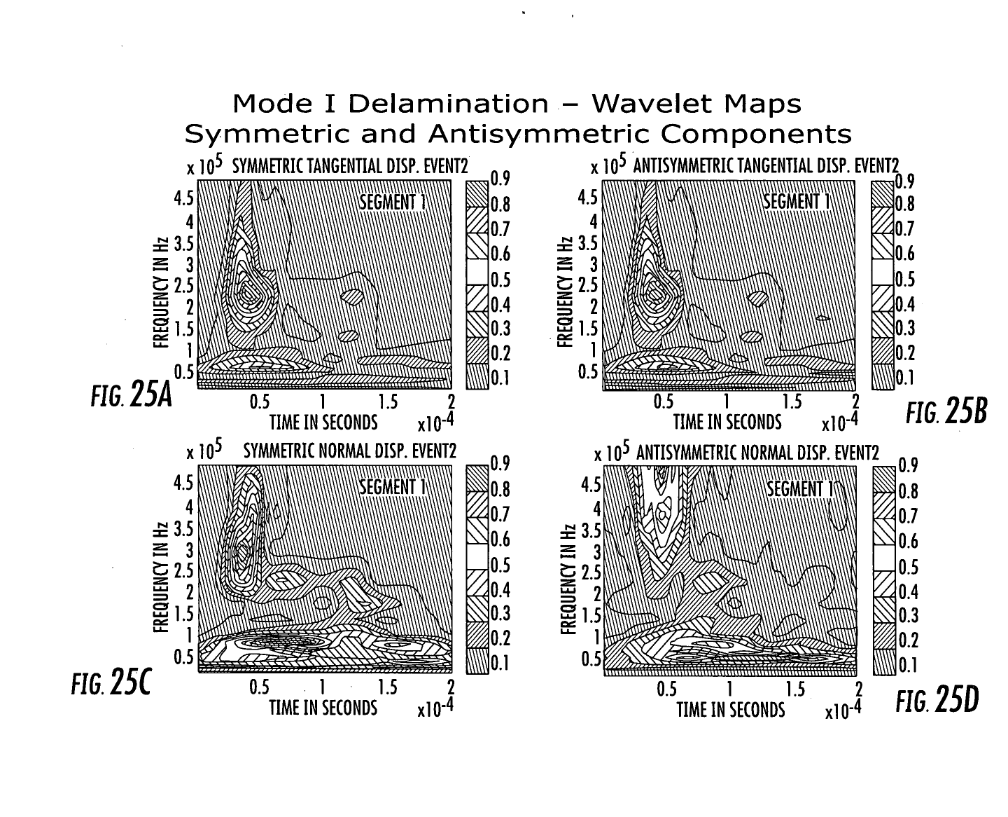

FIGS. 22A-22B illustrate the placement of normal sensors N1, N2 and shear sensors S1, S2 for a Mode I delaminating growth crack. The acoustic emission waveforms from the Mode I delaminating growth crack of FIGS. 22A-22B are shown in FIGS. 23A-23D. The corresponding symmetric and anti-symmetric tangential and normal displacement components are illustrated in FIGS. 24A-24D. The symmetric and anti-symmetric wavelet maps are shown in FIGS. 25A-25D.

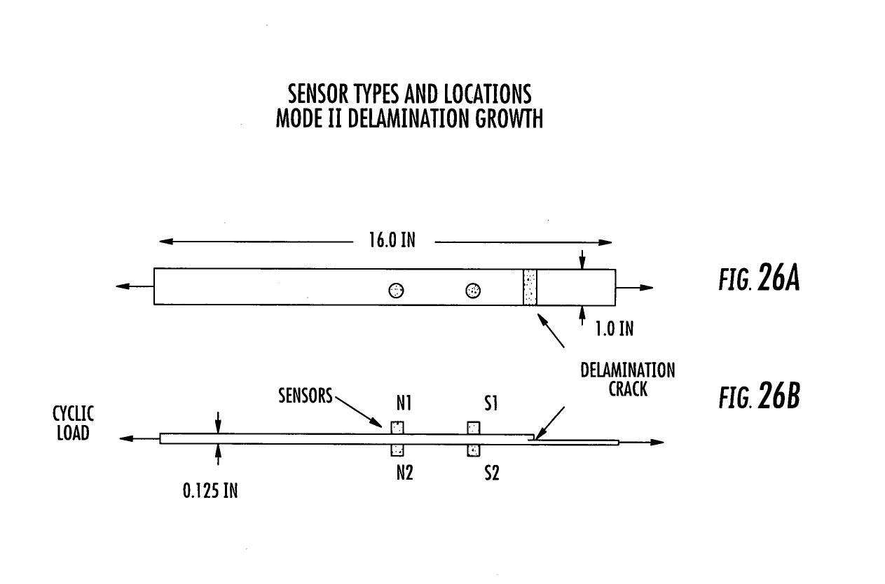

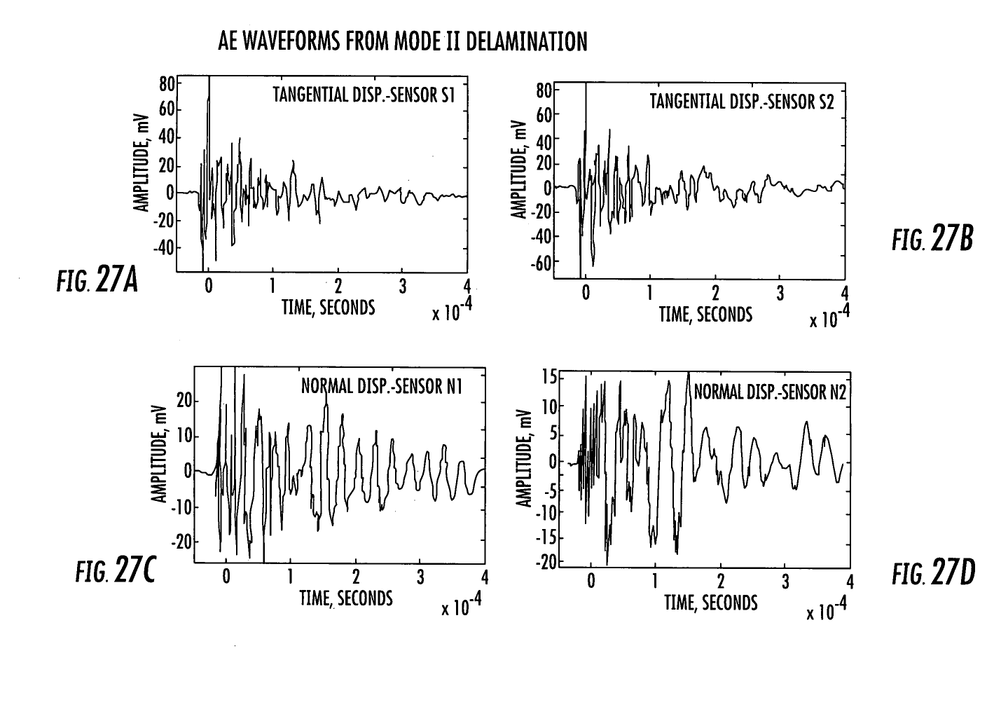

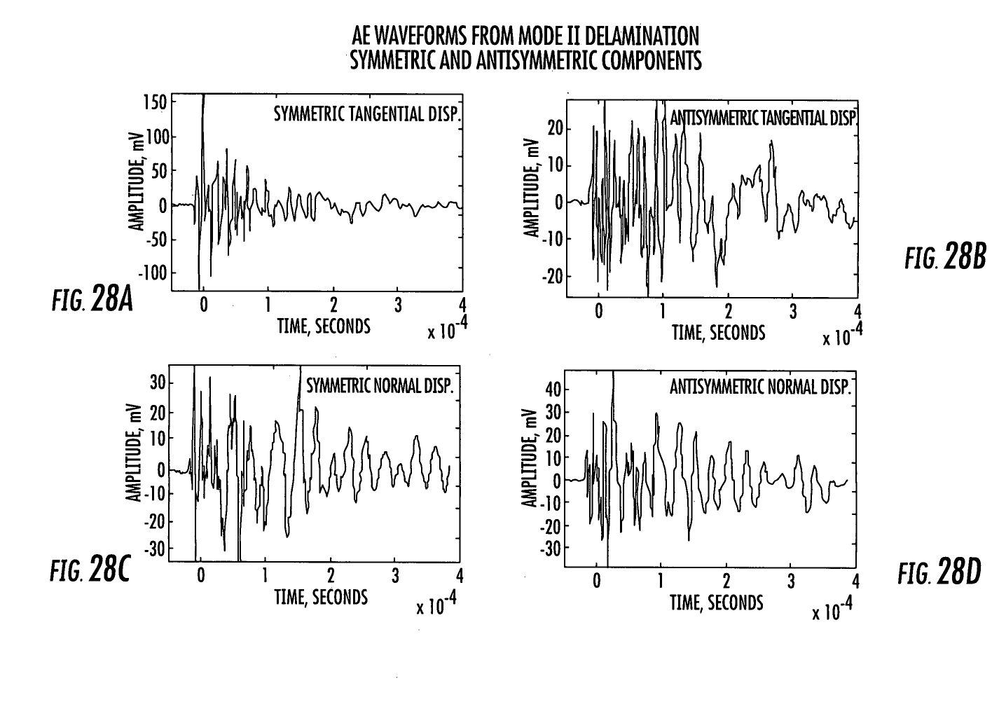

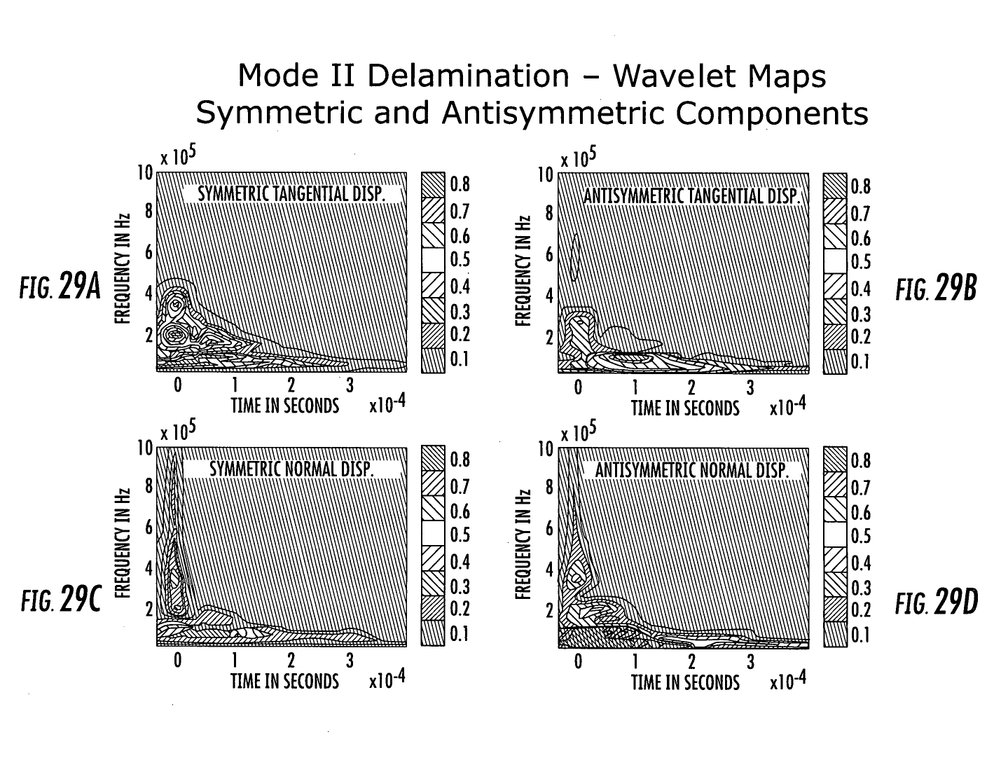

FIGS. 26A-26B illustrate the placement of normal sensors N1, N2 and shear sensors S1, S2 for a Mode II delaminating growth crack. The acoustic emission waveforms from the Mode II delaminating growth crack of FIGS. 27A-27B are shown in FIGS. 26A-26D. The corresponding symmetric and anti-symmetric tangential and normal displacement components are illustrated in FIGS. 28A-28D. The symmetric and anti-symmetric wavelet maps are shown in FIGS. 29A-29D.

A comparison of the waveforms, and in particular, of the wavelet maps corresponding to the various symmetric and anti-symmetric components of the tangential and normal displacements obtained from the sensors shows that the Mode I and Mode II crack growths result in very different wavelet maps. These differences may be expressed in terms of differences in frequency components and the duration of the event. These differences may be quantified through event parameters such as the acoustic emissions amplitude, duration, ratio of amplitude of symmetric versus anti-symmetric components of the acoustic emissions signals, and the like. Therefore, it is possible to distinguish between the acoustic emissions generated by individual failure modes as well as to distinguish between noise and valid acoustic emission signals from a structural event.

Embodiments of the present invention may be used in various environments where stress wave activity is monitored using multiple conventional sensors. This includes, but is not limited to: turbine engines where multiple conventional vibration sensors are used to detect resonant vibrations caused by flow and combustion instabilities; in rotating machinery to detect bearing damage or rotating unbalance; and for detecting damage in structures by monitoring stress wave propagation. In addition, embodiments of the present invention may be used for monitoring the structural integrity of airplanes, space vehicles, bridges, nuclear reactors as well as other types of pressure vessels, oil rigs, etc.

Certain modifications and improvements will occur to those skilled in the art upon a reading of the foregoing description. In the drawings and specification, there have been disclosed typical embodiments of the invention and, although specific terms are employed, they are used in a generic and descriptive sense only and not for purposes of limitation, the scope of the invention being set forth in the following claims.

1. A sensor assembly for non-destructively monitoring a structure to detect a structural event, the assembly comprising:
a plurality of acoustic sensor nodes configured to provide at least one sensor signal responsive to a structural event, the plurality of sensor nodes comprising one or more sensor nodes sensitive selectively to tangential displacement and one or more sensor nodes sensitive selectively to normal displacement; and
a signal analyzer configured to compare the sensor signal to a reference database of signal characteristics corresponding to respective structural events and to store and/or display a result to a user.

2. The sensor assembly of claim 1, wherein the signal analyzer is configured to identify a structural event mode based on the comparison to the reference database.

3. The sensor assembly of claim 2, wherein the structural event mode includes a direction of structural separation.

4. The sensor assembly of claim 1, wherein the sensor signal is a combined sensor signal from the plurality of sensor nodes.

5. The sensor assembly of claim 1, wherein the database of signal characteristics is experimentally determined based on known events in the monitored structure.

6. The sensor assembly of claim 1, wherein the database of signal characteristics is determined based on a computer model of the monitored structure.

7. The sensor assembly of claim 1, wherein the signal analyzer is further configured to determine an approximate location of a structural event based on the sensor signal.

8. The sensor assembly of claim 7, wherein the approximate location of a structural event is determined based on a time interval between electrical signals from each of the sensor nodes in the combined signal output.

9. The sensor assembly of claim 1, wherein the signal analyzer is configured to identify noise from the sensor signal based on the comparison to the reference database.

10. The sensor assembly of claim 1, wherein at least one of the sensor nodes includes a chemical sensor.

11. The sensor assembly of claim 1, wherein at least one of the sensor nodes includes an accelerometer.

12. The sensor assembly of claim 1, wherein at least one of the sensor nodes includes a piezoceramic sensor.

13. A method for non-destructively monitoring a structure to detect a structural event, the method comprising:
receiving at least one sensor signal from a plurality of acoustic sensor nodes responsive to a structural event, the plurality of sensor nodes comprising one or more sensor nodes sensitive selectively to tangential displacement and one or more sensor nodes sensitive selectively to normal displacement; and
comparing the sensor signal to a reference database of signal characteristics corresponding to respective structural events and to store and/or display a result to a user.

14. The method of claim 13, further comprising identifying a structural event mode based on the comparison to the reference database.

15. The method of claim 14, wherein the structural event mode includes a direction of structural separation.

16. The method of claim 13, wherein the sensor signal is a combined sensor signal from the plurality of sensor nodes.

17. The method of claim 13, further comprising experimentally determining the signal characteristics of known structural events in the monitored structure.

18. The method of claim 13, further comprising determining the signal characteristics of structural events based on a computer model of structural events in the monitored structure.

19. The method of claim 13, further comprising determining an approximate location of a structural event based on the sensor signal.

20. The method of claim 19, wherein the approximate location of a structural event is determined based on a time interval between electrical signals from each of the sensor nodes in the combined signal output.

21. The method of claim 13, further comprising identifying noise from the sensor signal based on the comparison to the reference database.

22. A computer readable medium encoded with a computer program for non-destructively monitoring a structure to detect a structural event and including computer readable program, the computer readable program comprising:
computer readable program code that receives at least one sensor signal from a plurality of acoustic sensor nodes responsive to a structural event, the plurality of sensor nodes comprising one or more sensor nodes sensitive selectively to tangential displacement and one or more sensor nodes sensitive selectively to normal displacement; and
computer readable program code that compares the sensor signal to a reference database of signal characteristics corresponding to respective structural events.
